(19) United States
(12) Patent Application Publication
(10) Pub. No.: US 2011/0261876 A1
(43) Pub. Date: Oct. 27, 2011

(54) METHOD FOR ENCODING A DIGITAL PICTURE, ENCODER, AND COMPUTER PROGRAM ELEMENT

(76) Inventors: Yih Han Tan, Singapore (SG); Wei Siong Lee, Singapore (SG); Jo Yew Tham, Singapore (SG); Susanto Rahardja, Singapore (SG)

(21) Appl. No.: 13/124,485

(22) PCT Filed: Oct. 16, 2009
(86) PCT No.: PCT/SG2009/000381

§ 371 Date: Jul. 14, 2011

Related U.S. Application Data
(60) Provisional application No. 61/106,276, filed on Oct. 17, 2008.

(51) Int. Cl. H04N 7/26

(52) U.S. Cl. 375/240.01

(57) ABSTRACT

A method for encoding a digital picture having a plurality of pixels is described, each pixel being associated with at least one of a plurality of groups of pixels comprising associating each group of pixels with a first coding mode; determining, for each group of pixels, a first encoding performance level according to its associated first coding mode; determining at least one group of pixels of the plurality of group of pixels such that the first encoding performance level of the at least one determined group of pixels fulfils a predetermined quality criterion; determining, for the determined group of pixels, a second encoding performance level according to a second coding mode; comparing the first performance level and the second performance level; associating the second coding mode with the determined group of pixels if the result of the comparison fulfils a predetermined association criterion; and encoding each group of pixels using its associated coding mode.

### FIELD OF THE INVENTION

Embodiments generally relate to a method for encoding a digital picture, encoder, and computer program element

### BACKGROUND OF THE INVENTION

Real-time H.264/AVC and scalable video coding (SVC) are challenging tasks due to their high complexity. H.264/AVC is a joint project of the ITU-T VCEG and ISO/IEC MPEG. Though it is similar to prior coding standards in using transform coding of prediction errors, it includes many features that lead to significant coding performance gain over previous video coding standards. Scalable Video Coding (SVC) is an on-going standard and the current working draft is an extension of H.264/AVC. Though they are similar to prior coding standards in using transform coding of prediction error, real-time H.264/AVC and scalable video coding (SVC) include many features that lead to significant coding performance gain over previous video coding standards.

According to H.264/AVC and SVC, in order to fully exploit their features to gain optimal rate-distortion (R-D) performance, the encoder checks all possible coding modes and selects the best one. However, this exhaustive method is computationally expensive. Encoding methods that allow a complexity reduction are desirable to achieve real-time encoding performance with minimal impact on optimal rate-distortion performance. This has motivated many fast encoding methods which allow encoding complexity reduction for sub-optimal R-D performance. These fast algorithms work by testing only a subset of all possible modes; coding modes that are judged to be less probable are omitted from R-D operations.

Fast search algorithms during block-based motion estimation also play a big part in reducing the complexity of the encoding process. These algorithms reduce the number of search points by following a pre-defined search path that can be shown to result in good prediction using stop criteria during searches or using good starting points for searches.

In spite of the presence of numerous effective fast encoding algorithms, it is difficult to use these strategies to control the encoding process to achieve a good arbitrary trade-off between complexity and coding efficiency as the rate-distortion of each macro block (MB) is computed independently from neighbouring macro blocks.

Some encoder complexity scalable schemes have previously been proposed. For example, dynamically parameterized architectures have been proposed for motion estimation and discrete cosine transform. These enable the video encoding process to gracefully degrade in power-constraint environments.

As another example, the complexity of H.263+ encoding is controlled by pre-determining the proportion of the SKIP coding mode (macro blocks are computationally less expensive to code using SKIP mode) and restricting the search range during motion estimation and assigning more sum of absolute differences (SAD) computations to regions that are predicted to have high motion content. Complexity control may also be achieved by empirically determining a set of encoder operation modes that give different complexity-performance trade-offs.

The extensive use of variable block sizes for motion estimation in emerging video coding systems results in mode decisions (and the accompanying motion estimation) taking up a larger proportion of encoding time and motion vectors are also more unpredictable in nature.

Sophisticated forward, backward and bidirectional prediction algorithms also add new dimensions to the motion estimation and mode decision process. The popular hierarchical-B coding structure also requires prediction between frames which are temporally further apart, possibly necessitating a large search range for effective motion-estimated prediction.

A typical implementation of an encoder can be computationally complex for a few reasons: a large number of SAD operations carried out during motion searches, interpolations for sub pixel motion estimation and transform and inverse transform operations during the computation of the number of bits required for each coding mode during rate-distortion computations. Any algorithm that can reduce the number of these operation or implementation techniques that can speed them up can conceivably increase the speed of the encoder.

### SUMMARY OF THE INVENTION

In one embodiment, A method for encoding a digital picture having a plurality of pixels, each pixel being associated with at least one of a plurality of groups of pixels is provided including associating each group of pixels of the plurality of groups of pixels with a first coding mode of a plurality of different coding modes; determining, for each group of pixels, a first encoding performance level specifying an encoding performance level of the group of pixels when encoded according to its associated first coding mode; determining at least one group of pixels of the plurality of group of pixels such that the first encoding performance level of the at least one determined group of pixels fulfils a predetermined quality criterion; determining, for the determined group of pixels, a second encoding performance level, specifying an encoding performance level of the group of pixels when encoded according to a second coding mode which is different from the first coding mode; comparing the first performance level and the second performance level; associating the second coding mode with the determined group of pixels if the result of the comparison fulfils a predetermined association criterion; and encoding each group of pixels using its associated coding mode.

According to other embodiments, an encoder and a computer program product according to the method for encoding a digital picture described above are provided.

Embodiments described in the following in connection with the method for encoding a digital picture are analogously valid for the encoder and the computer program product.

### SHORT DESCRIPTION OF THE FIGURES

Illustrative embodiments of the invention are explained below with reference to the drawings.

FIG. 1 shows an encoder according to an embodiment.

FIG. 2 illustrates motion estimation according to one embodiment.

FIG. 3 shows a flow diagram according to an embodiment.

FIG. 4 shows an encoder according to an embodiment.

FIG. 5 shows a plurality of macro blocks.

FIG. 6 shows a decomposition of a digital picture into a plurality of macro-blocks.

### DETAILED DESCRIPTION

According to one embodiment, a complexity scalable rate-distortion encoding method is provided that is, according to one embodiment, suitable for H.264/AVC and SVC (scalable video coding). Complexity scalability, where the computational complexity of an encoder can be scaled with a trade-off in coding performance, may be a valuable tool. When computational resources are limited but a fast implementation of the encoder is required, the complexity of the encoder may be scaled down to ensure that encoding can be done on time to meet real-time encoding requirements or to meet power constraints (e.g. constraints with regard to the allowable power consumption of the encoding process). Real-time encoding may typically be required for applications such as live broadcast, surveillance or video communication. Considering that these applications may be built on a wide variety of computing platforms to make full use of computational resource while ensuring that encoding completes on time would be difficult without an effective complexity scalable solution.

During scalable video encoding, the encoding complexity of each layer may be controlled independently, making the allocation of computational resource across layers possible.

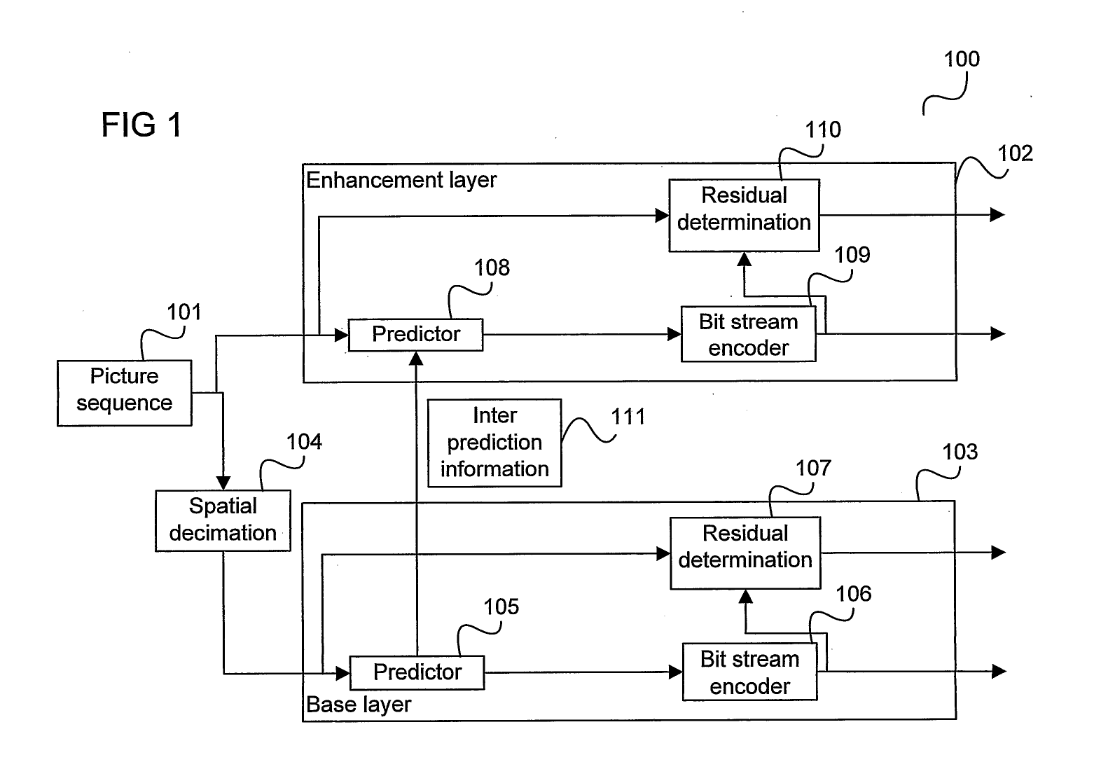

An encoder according to one embodiment allowable scalable video encoding is described in the following with reference to FIG. 1.

FIG. 1 shows an encoder 100 according to an embodiment.

The encoder 100 receives a digital picture sequence 101 including a plurality of temporally ordered digital pictures (also referred to as frames or slices) as input.

The digital picture sequence 101 is supplied to an enhancement layer module 102 and a base layer module 103.

The input of the enhancement layer module 102 and the base layer module 103 may differ in spatial resolution. For example, the spatial resolution of the digital picture sequence 101 is reduced by a spatial decimation circuit 104 before it is fed to the base layer module 103.

For example, a base layer frame size is one-quarter of the size of an enhancement layer frame. For example, QCIF-size (176×144) is used for the base layer while CIF-size (352×288) is the original frame size and is used for the enhancement layer. As another example, CIF-size frames are fed to the base layer for 4CIF-size (704×576) frames of the digital picture sequence 101. However, the enhancement layer and the base layer may also differ in other coding parameters and the spatial resolution may be the same for the enhancement layer and the base layer.

A digital picture fed to the base layer module 103 is supplied to a first prediction circuit 105 that generates prediction information for the digital picture. For example, the first prediction circuit 105 determines motion vectors based on which the digital picture may be approximated using a previous or a following digital picture in the picture sequence 101. The output of the first predictor 105 is fed to a first bit stream coding circuit 106 which generates a first coding bit-stream, for example a H.264/AVC compatible base layer bit-stream.

The output of the first bit stream coding circuit 106 and the digital picture is further supplied to a first residual determination circuit 107 which calculates the residuals of the prediction of the digital picture, i.e. which generates information from which the errors made in the approximation of the digital picture by the prediction may be determined.

In other words, compression of the digital picture is achieved by coding the prediction parameters (such as estimated motion vectors) and the errors of the prediction with respect to the original digital picture.

Similarly, a digital picture fed to the enhancement layer module 102 is supplied to a second prediction circuit 108 that generates prediction information for the digital picture. The output of the second predictor 108 is fed to a second bit stream coding circuit 109 which generates a second coding bit-stream, for example a H.264/AVC compatible base layer bit-stream.

The output of the second bit stream coding circuit 109 and the digital picture is further supplied to a second residual determination circuit 110 which calculates the residuals of the prediction of the digital picture.

In the prediction of the digital picture in the enhancement layer (i.e., e.g., at higher resolution) inter prediction information 111 from the prediction of the digital picture in the base layer (i.e., e.g., at lower resolution) may be used. For example, the enhancement layer prediction information may be determined based on the reconstruction of the digital picture from the coding information generated by the base layer module 103, e.g. by up-sampling the reconstructed base layer picture.

For the prediction, both the first prediction circuit 105 (i.e. the prediction circuit of the base layer) and the second prediction circuit 108 (i.e. the prediction circuit of the enhancement layer) may use motion estimation.

A decoder may be supplied with the prediction parameters (such as estimated motion vectors) and the residuals (i.e. information about the differences between the original picture and its prediction based on the prediction parameters). From this, the decoder may reconstruct the digital picture.

Typically, within a video frame, the nature of the video data is not uniform, i.e., there are texture-filled, edge-filled and homogeneous regions. Therefore, the levels of motion activity of a digital picture with regard to another digital picture that is used as reference frame for motion estimation may also vary over the regions of the digital picture. Therefore, according to one embodiment, a video frame (i.e. a digital picture of the digital picture sequence 101) is partitioned into macro blocks and motion estimation is carried out for the macro blocks independently.

Furthermore, the use of variable block-sizes of the blocks for which motion estimation is carried out between two frames can significantly improve coding performance. Using a smaller block size requires the coding of more header information but can provide better motion compensated prediction, especially when coding regions with high motion activity.

According to one embodiment (and in accordance with H.264/AVC) several macro block coding modes for motion compensated prediction may be used, wherein each mode corresponds to a specific partition of a 16×16 macro block. According to one embodiment, a macro block may be divided into blocks of 16×16, 16×8, 8×16 and 8×8 luminance samples. Each 8×8 sub-block may be further partitioned into blocks of 8×8, 8×4, 4×8, 4×4 luminance samples. A luminance sample, or, more generally, a pixel value, is associated with one pixel. In other words, a 8×8 sub-block, for example, may cover 8'8 pixels of the original digital picture to be encoded.

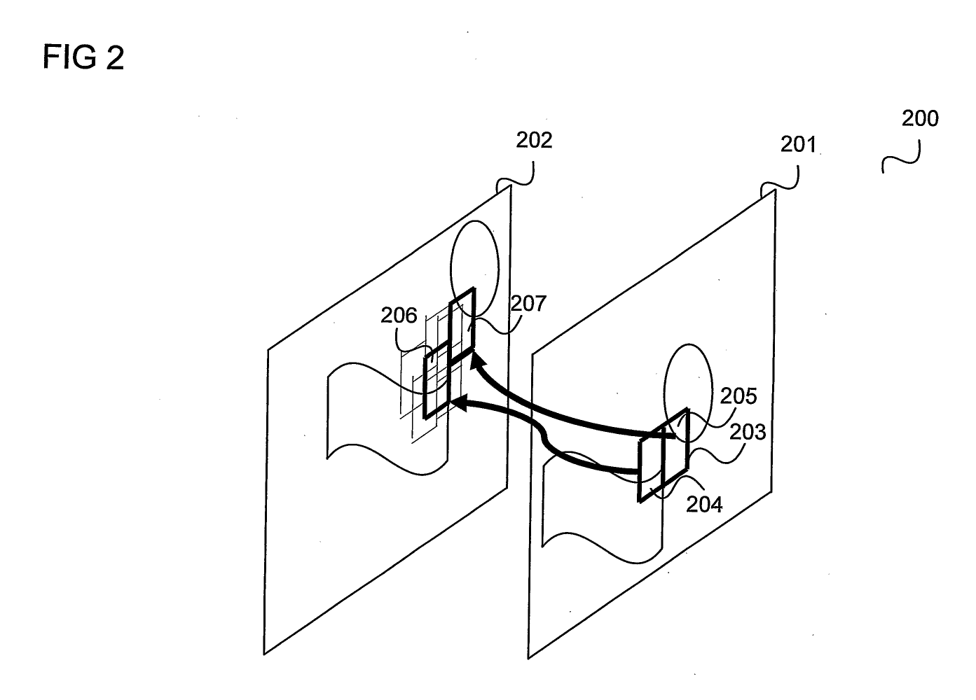

Motion estimation based on macro block partitioning is illustrated in FIG. 2.

FIG. 2 illustrates motion estimation according to one embodiment.

According to the motion estimation in this example, a first digital picture 201 of the digital picture sequence 101 is used for predicting a second digital picture 202 of the digital picture sequence 101 using motion estimation. In this example, a macro block 203 is partitioned into a first sub block 204 and a second sub block 205. Motion vectors are estimated such that the first sub block 204 is mapped to a first block 206 of the second digital picture 202 and the second sub block 205 is mapped to a second block 207 of the second digital picture 202. The mappings (and correspondingly the motion vectors) are selected such that the content (i.e. the luminance values) of the first sub block 204 matches the content of the first block 206 as good as possible (according to a predetermined matching measure such as the SSD as explained below) and such that the content of the second sub block 205 matches the content of the second block 207 as good as possible.

As mentioned, a partitioning of a macro block may be used to achieve low prediction errors for picture regions with large motion activity from the frame used as prediction reference frame to the picture to be predicted.

On the other hand, the SKIP mode (according to H.264) and large block sizes are effective for coding stationary regions with little motion activity. To fully exploit the benefits of variable block-size motion compensation, the encoder may adaptively choose the most effective partition size during motion estimation for each macro block.

The large number of coding modes (corresponding to the possible partitions of a macro block) that are available for the encoding of each macro block gives rise to a multiplicity of possible combinations of coding modes from which the encoder may choose a combination of coding modes that leads to a good compression (or possibly the best compression from among the available coding mode combinations). Since the number of combinations may be very high, the selection of the coding modes for the macro blocks may be a time-consuming and challenging optimization task to be carried out by the encoder.

According to one embodiment, during motion estimation, e.g. for determining the first block 206 in the second digital picture 202 for the first sub-block 204, the encoder selects the motion vector, \tilde{m}=[mₓ, m_{y}] such that the cost function

J(\tilde{m}, λₘₒₜ)=SAD+λₘₒₜR(\tilde{m}) (1)

is minimized where SAD is the sum of absolute differences between the original signal and predicted signal, i.e., between the block to be mapped and the block to which it is mapped to, i.e., for the current example, between the first block 206 in the second digital picture 202 and the first sub-block 204. The differences are for example calculated between the luminance values of the two blocks.

R(\tilde{m}) is the number of bits required to code the motion vector \tilde{m} and

λₘₒₜ=0.92·2^{(q-12)/6}. (2)

Here, q denotes the quantization parameter (e.g. q=42).

For each macro block, the coding mode to be used for the macro block may be chosen after motion estimation, e.g. based on the rate distortion performance of the macro block as it can be achieved for a certain coding mode by motion estimation. The rate distortion (R-D) performance may for example be expressed as a rate distortion cost (R-D cost).

The coding mode may be chosen such that it leads to the lowest R-D cost for the macro block by minimizing the following cost function:

J(mode, λ_{mod})=SSD+λ_{mod}R(mode), (3)

where SSD is the sum of squared differences between the block to be mapped and the block to which it is mapped to, R(mode) is the number of bits needed to code the macro block using mode and

λ_{mod}=λₘₒₜ²=0.85·2^{(q-12)/3}. (4)

If Jₖ(modeₖ, λ_{mode} _{ₖ}) is the Lagrangian cost function of the k^{th} macro block that is coded with mode modeₖ and mode is the N−tuple (mode₀, . . . , mode_{N-1}), where N is the total number of macro blocks, additive distortion and rate measures may be assumed such that the (optimal) coding mode selection may be based on the following optimization problem:

$${min}_{mode} {\sum }_{k = 0}^{N - 1} {J}_{k} ( mode , {λ}_{{mode}_{k}} ) = {\sum }_{k = 0}^{N - 1} {min}_{{mode}_{k}} {J}_{k} ( {mode}_{k} , {λ}_{{mode}_{k}} ) . \qquad ( 5 )$$

That is, for each macro block the coding mode may be selected that gives the best R-D performance.

In one embodiment, the coding modes for a subset of macro blocks may be optimized concurrently wherein computational resources are channelled to those macro blocks that have the worst R-D performance.

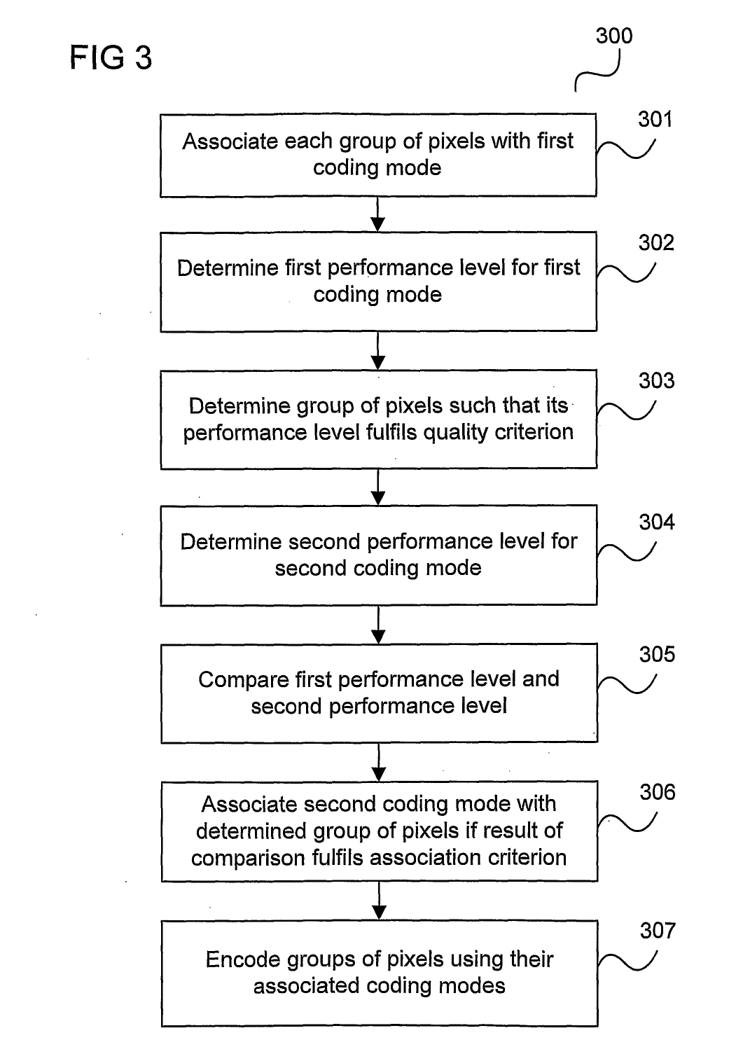

This is explained in the following with reference to FIG. 3.

FIG. 3 shows a flow diagram 300 according to an embodiment.

The flow diagram 300 illustrates a method for encoding a digital picture having a plurality of pixels, each pixel being associated with at least one of a plurality of groups of pixels.

In 301, each group of pixels of the plurality of groups of pixels is associated with a first coding mode of a plurality of different coding modes. The first coding mode may be an initial coding mode equal for all groups of pixels or may be different (e.g. in later stages of the coding mode association process, e.g. after some iterations) for different groups of pixels.

In 302, for each group of pixels, a first encoding performance level specifying an encoding performance level of the group of pixels when encoded according to its associated first coding mode is determined. In other words, the first encoding performance level specifies the performance level (e.g. an R-D performance) as it would arise if the group of pixels was coded using the first coding mode.

In 303, at least one group of pixels of the plurality of group of pixels such that the first encoding performance level of the at least one determined group of pixels fulfils a predetermined quality criterion is determined.

In 304, a second encoding performance level is determined for the determined group of pixels specifying an encoding performance level of the group of pixels when encoded according to a second coding mode which is different from the first coding mode. In other words, the second encoding performance level specifies the performance level (e.g. an R-D performance) as it would arise if the determined group of pixels was coded using the second coding mode.

In 305, the first performance level and the second performance level are compared.

In 306, the second coding mode is associated with the determined group of pixels if the result of the comparison fulfils a predetermined association criterion.

In 307, each group of pixels is encoded using its associated coding mode.

In other words, in one embodiment, the group of pixels for which the performance of a second coding mode is tested is determined based on its relative performance for a first coding mode with respect to the other groups of pixels. For example, it is tested for the group of pixels that has the worst or a low performance, e.g. a group of pixels for which the first (encoding) performance level is below a predetermined threshold (corresponding to the pre-determined quality criterion) how the second coding mode performs (i.e. what is the second performance level). This may be seen as a channelling of the resources available for the coding mode association to the groups of pixels with, e.g., currently lowest performance.

In one embodiment, the second coding mode is or is not associated with the determined group of pixels depending on the result of a comparison of the first (encoding) performance level and the second (encoding) performance level. For example, the second coding mode is associated with the determined group of pixels in case that the second performance level is higher (or, in one embodiment, at least as high) as the first performance level. In other words, the first coding mode is replaced by the second coding mode if the second coding mode is better (or, in one embodiment, at least as good) as the first coding mode.

It should be noted that it is not necessary that all groups of pixels are encoded after 301 to 306. For example, a group of pixels may be encoded (e.g. in course of the determination of the first performance level) while 301 to 306 are still carried out for other groups of pixels. 301 to 306 may be seen as a coding mode associating process for the groups of sub-pixels. For example 301 to 306 form one iteration of a coding mode associating process that includes a plurality of iterations.

Each group of pixels for example covers a continuous area of the digital picture. The size and shape of the continuous area may be equal for all groups of pixels. The plurality of groups of pixels may cover the digital picture completely or may also be a sub-group of a plurality of group of pixels covering the digital picture completely. For example, the plurality of groups of pixels may be a plurality of groups of pixels arranged in a certain pattern on the digital picture (e.g. in accordance with a “wave front” as explained below). The coding mode associating process may for example be carried out for a plurality of groups and pixels and, after it has been completed for this plurality of groups and pixels, be carried out for a following plurality of groups and pixels.

In one embodiment, the groups of pixels are blocks, e.g. macro blocks, for example in accordance with H.264/AVC.

In one embodiment, the first encoding performance level fulfils the quality criterion if is below a threshold, e.g. a pre-determined threshold.

In one embodiment, the first encoding performance level fulfils the quality criterion if it is a lowest encoding performance level of the first encoding performance levels.

In one embodiment, the result of the comparison fulfils the predetermined association criterion if the second encoding performance level is higher than the first encoding performance level.

In one embodiment, the result of the comparison fulfils the predetermined association criterion if the second encoding performance level is at least as high as the first encoding performance level.

In one embodiment, the encoding performance level of a group of pixels when encoded according to a coding mode is the rate-distortion performance of the group of pixels.

In one embodiment, the method includes carrying out a plurality of iterations wherein in each iteration
a current encoding performance level is determined for each group of pixels specifying a current encoding performance level of the group of pixels when encoded according to its currently associated coding mode;
at least one group of pixels of the plurality of group of pixels for the current iteration is determined such that the current encoding performance level of the at least one determined group of pixels for the current iteration fulfils the predetermined quality criterion;
a test encoding performance level is determined for the determined group of pixels for the current iteration, specifying an encoding performance level of the group of pixels when encoded according to a test coding mode which is different from the current coding mode;
the current performance level and the test performance level are compared;
the test coding mode is associated with the determined group of pixels for the current iteration if the result of the comparison fulfils the predetermined association criterion.

In other words, the method described above where a group of pixels is determined and a second performance level is compared with a first performance level and possibly associated with the determined group of pixels may be iteratively repeated. The first coding mode may thus be seen as the current coding mode for a specific iteration and the second coding mode may be seen as the test coding mode for a specific iteration. It should be noted that even if the second coding mode is associated with the determined group of pixels the coding mode associated with the determined group of pixels may change again in one or more later iterations. The coding mode that is associated with a group of pixels finally, i.e. after the last iteration has been carried out, is for example used for the encoding of the group of pictures. All examples and possible configurations of the first coding mode and the second coding mode are analogously valid for the current coding mode and the test coding mode.

In one embodiment, the at least one group of pixels of the plurality of group of pixels for the current iteration is determined by a comparison of current encoding performance levels of the plurality of group of pixels.

In one embodiment, the iterations are carried out until a termination condition is fulfilled. In other words, an iterative coding mode associating process is carried out (including iterations as described above) until a termination condition is fulfilled.

In one embodiment, the termination condition is determined based on available computational resources.

The termination condition is for example that a maximum number of iterations has been reached.

In one embodiment, the termination condition is based on an estimation of computational resources necessary for encoding the digital picture.

The termination condition may be based on an estimation of the time necessary for encoding the digital picture.

In one embodiment, the second coding mode is determined from the first coding mode in accordance with a pre-determined rule. The second coding mode may also be determined based on a test coding mode of a previous iteration.

For example, the second coding mode is determined from the first coding mode in accordance with a pre-determined rule.

In one embodiment, the digital picture is encoded according to a base layer and according to an enhancement layer, wherein the coding mode associated with the determined group in the enhancement layer is determined from a coding mode associated with the determined group of pictures to be used for encoding the digital picture in accordance with the base layer in accordance with a pre-determined rule.

For example, the digital picture is encoded according to a base layer and according to an enhancement layer, wherein the first coding mode associated with the determined group is a coding mode to be used for encoding the digital picture in accordance with the enhancement layer and the second coding mode is determined from a coding mode associated with the determined group of pictures to be used for encoding the digital picture in accordance with the base layer in accordance with a pre-determined rule.

In other words, the digital picture may be encoded into base layer data and enhancement layer data and for the base layer and the enhancement layer, each group of pixels has an associated coding mode that may be associated independently from the other layer. The second coding mode (in other words the coding mode being tested) for the enhancement layer may be based on the coding mode that is currently associated with the group of pixels for the encoding in the base layer. This coding mode may for example be the coding mode that is (finally) to be used for encoding the group of pixels in the base layer.

In one embodiment, the first coding mode and the second coding mode specify, for a group of pixels, a partitioning of the group of pixels.

The partitioning of the group of pixels may be used as a basis for a prediction of pixel values of the group of pixels in encoding the group of pixels (i.e. for or during encoding the group of pixels).

In one embodiment, the partitioning of the group of pixels is used as a basis for a prediction of pixel values of the group of pixels in encoding the group of pixels by motion estimation.

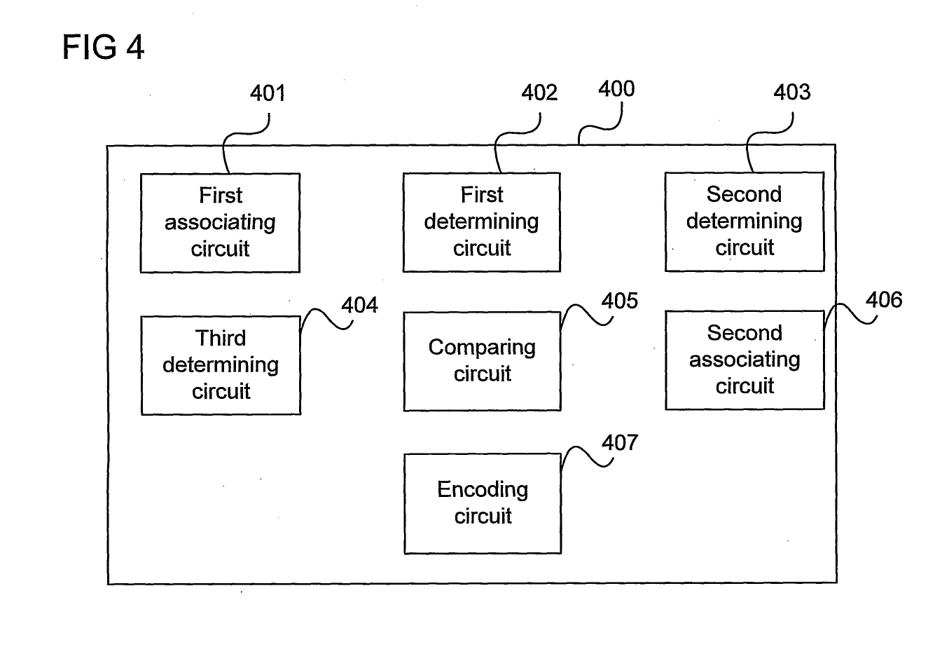

The method illustrated in FIG. 3 is for example carried out by an encoder as illustrated in FIG. 4.

FIG. 4 shows an encoder 400 according to an embodiment.

The encoder 400 is an encoder for encoding a digital picture having a plurality of pixels, each pixel being associated with at least one of a plurality of groups of pixels.

The encoder 400 includes a first associating circuit 401 configured to associate each group of pixels of the plurality of groups of pixels with a first coding mode of a plurality of different coding modes.

The encoder 400 further includes a first determining circuit 402 configured to determine, for each group of pixels, a first encoding performance level specifying an encoding performance level of the group of pixels when encoded according to its associated first coding mode.

The encoder 400 further includes a second determining circuit 403 configured to determine at least one group of pixels of the plurality of group of pixels such that the first encoding performance level of the at least one determined group of pixels fulfils a predetermined quality criterion.

The encoder 400 further includes a third determining circuit 404 configured to determine, for the determined group of pixels, a second encoding performance level, specifying an encoding performance level of the group of pixels when encoded according to a second coding mode which is different from the first coding mode.

The encoder 400 further includes a comparing circuit 405 configured to compare the first performance level and the second performance level.

The encoder 400 further includes a second associating circuit 406 configured to associate the second coding mode with the determined group of pixels if the result of the comparison fulfils a predetermined association criterion.

The encoder 400 further includes an encoding circuit 407 configured to encode each group of pixels using its associated coding mode.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment. A computer program product is for example a computer readable medium on which instructions are recorded which may be executed by a computer, for example including a processor, a memory, input/output devices etc.

In one embodiment, to reduce inter-symbol redundancies, a part of a digital picture may be predicted using other parts of the digital picture, i.e. intra prediction may be carried out, for example by the predictor 105, 108. The intra prediction is for example carried out in accordance with the H.264 video coding standard.

Intra prediction is designed to exploit spatial correlation within a picture by predictively coding pixel values based on neighbouring pixel values, e.g. by predicting a macro-block based on a neighbouring macro block.

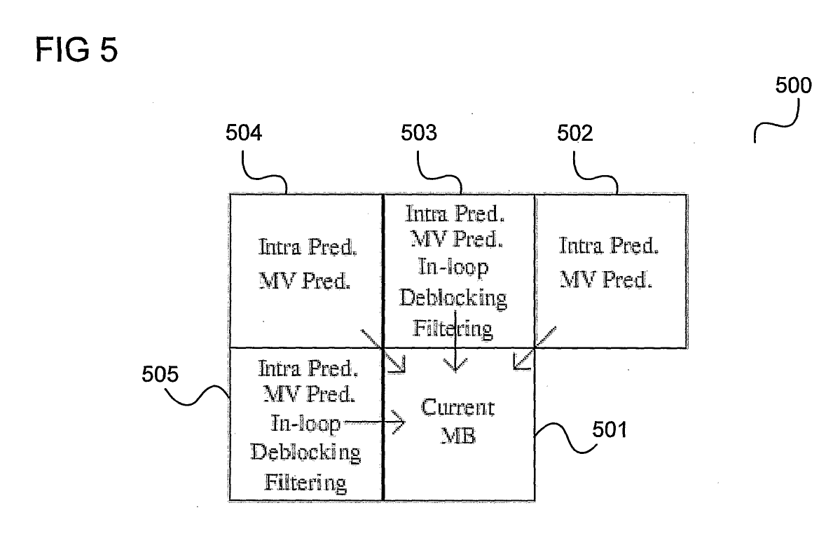

The prediction of the pixel values of a macro block based on neighbouring macro blocks according to one embodiment is illustrated in FIG. 5.

FIG. 5 shows a plurality of macro blocks 500.

In FIG. 5, the plurality of macro blocks 500 is shown corresponding to its arrangement on the digital picture to be encoded. A current macro block 501 is the macro block to be encoded using a prediction based on the other macro blocks 502, 503, 504, 505 of the plurality of macro blocks 500. In this example, all the other macro blocks 502, 503, 504, 505 are used for intra predicting the current macro block 501.

Further, in one embodiment, the motion vectors estimated for the other macro blocks 502, 503, 504, 505 are used to predict the motion vector to be estimated for the current macro block 501. For example, the motion vector to be estimated for the current macro block 501 is predicted based on the median of the motion vectors of the other (neighbouring) macro blocks 502, 503, 504, 505. Due to strong correlation among neighbouring motion vectors, the difference between an estimated motion vector and its prediction has lower entropy than the estimated motion vector itself. Thus, higher compression of the digital picture may be achieved by coding the difference between the estimated motion vector and its prediction instead of the estimated motion vector itself.

Additionally, pixel information from one or more of the other (neighbouring) macro blocks 502, 503, 504, 505 (in this example of the macro block 505 to the left of the current macro block 501 and of the macro block 503 to the top of the current macro block 501) may be used for encoding the current macro block 501 using in-loop deblocking filtering.

In one embodiment, when a current macro block is predicted using other (e.g. neighbouring) macro blocks, reconstructed pixel values of the other macro blocks are required for intra prediction of the current macro block. Therefore, the other macro blocks are encoded and reconstructed before the current macro block is encoded.

For example, in one embodiment, carrying out the R-D process (i.e. the coding mode association process) of the current macro block 501 requires that the R-D process of the other macro blocks 502, 503, 504, 505 is completed.

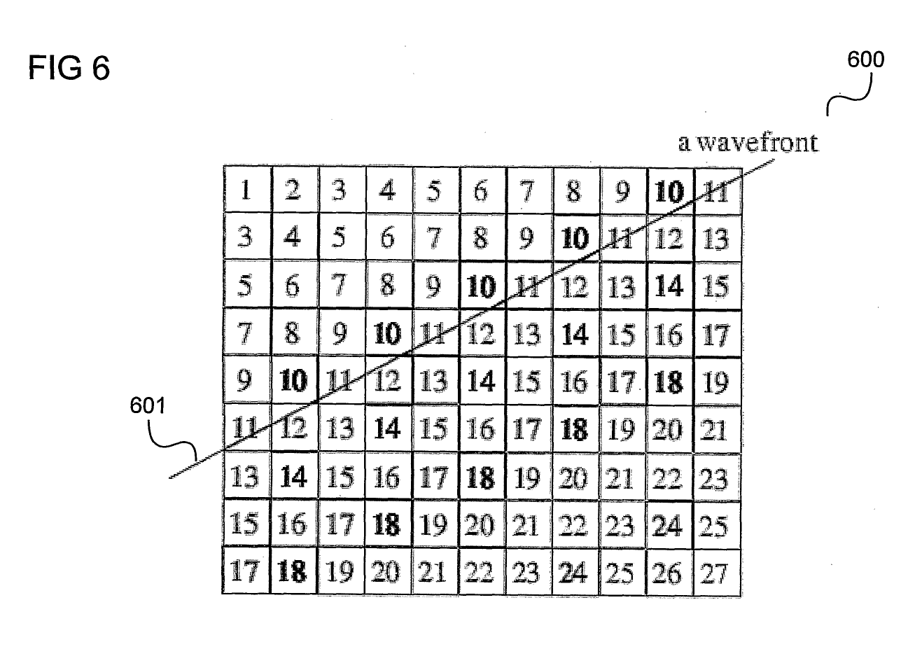

To allow parallelized processing on multiple processors in spite of this data dependency an encoding mechanism is used in according to one embodiment that is based on the idea of a “wave front” of macro blocks. This is illustrated in FIG. 6.

FIG. 6 shows a decomposition of a digital picture 600 into a plurality of macro-blocks.

The digital picture is divided into a plurality of macro blocks, i.e. each pixel of the digital picture is, in this example, associated with exactly one macro block.

Each macro block is assigned a number (given in FIG. 6) that is the number of a sub group Wⱼ of the macro blocks. The macro blocks of each sub groups of macro blocks are selected such that they are arranged in a pattern such that the sub group may be seen as a wave front traversing the digital picture as for example indicated by line 601.

As can be seen, the sub-groups of macro blocks are selected such that they may be encoded in the order according to their numbering while the data dependencies as given by FIG. 5 are fulfilled.

Thus, the wave front approach is in one embodiment used for macro block level partitioning to overcome the problem of excessive data dependency that is present within a frame.

Further, the sub-groups are selected such that at various stages, all macro blocks of one sub-group (one “wave front”) can be processed independently.

In one embodiment, macro blocks belonging to the same wave front undergo the R-D optimization (i.e. the coding mode associating process) concurrently.

In the following, an encoding scheme according to one embodiment is described. The encoding scheme is described to be based on the wave front approach described above. However, it may also be based on other groups of macro blocks instead of a wave front, for example for all macro blocks of a digital picture.

The encoding scheme described in the following is for example carried out by the encoder 100 shown in FIG. 1 or the encoder 300 shown in FIG. 3.

The encoding scheme described allows the R-D computation of the video encoding process to be carried out in a complexity scalable fashion.

Let MB_{i,j} be the i^{th} macro block in the wave front Wⱼ and J_{i,j}(mode, λ_{mode}) be the R-D cost of MB_{i,j}, where

J_{i,j}(mode, λ_{mode})=SSD+λ_{mode}R(mode). (6)

To encode a slice (i.e. a frame or digital picture), the wave fronts Wⱼ are processed in an order of ascending j, starting from j==0 (or starting from 1 in the numbering used in FIG. 6). For each wave front Wⱼ, all macro blocks are initially assigned with a first coding mode that may be seen as an initial candidate coding mode. This initial coding mode is for example the SKIP mode according to H.264.

After this initialization, the encoder optimizes the assigned coding modes iteratively.

In each iteration, a macro block is selected in Wⱼ to be processed (i.e. to compute the R-D cost). The selection of the macro block MB* to be processed is for example done such that

$${MB}^{*} = arg {max}_{{MB}_{i , j}} {J}_{i , j} ( mode\_min ( {MB}_{i , j} ) , {λ}_{mode} ) , \qquad ( 7 )$$

where mode_min(MB_{i,j}) is the coding mode currently assigned with macro block MB_{i,j}. The coding mode mode_min(MB_{i,j}) is the macro block coding mode giving currently the best (minimum) R-D cost for MB_{i,j} from among the coding codes that have been tested for MB_{i,j}.

In other words, for the next macro block to be processed MB*, the macro block of the wave front is selected that has, with regard to its currently assigned coding mode, the worst R-D cost of all the macro blocks of the wave front.

For MB*, a macro block mode mode_{Test} is tested for MB* that may for example be dependent on the coding mode that has been previously tested for MB*, e.g. the coding mode that has been previously tested for MB* (e.g. in a previous iteration), if any, or that may be dependent on the coding mode currently assigned to MB*:

For example, mode_{Test} is selected according to table 1 depending on the coding mode previously tested. It should be noted that 8×8 coding mode is in this example the mode leading to the least distortion. When this coding mode has been tested for a macro block, no coding mode is tested for this macro block.

TABLE 1
Next macro block mode to test

| previous macro block coding | next macro block coding mode |
|---|---|
| mode tested for MB* | to test for MB* |
| SKIP | 16x16 |
| 16x16 | 16x8 |
| 16x8 | 8x16 |
| 8x16 | 8x8 |
| 8x8 | end |

In one embodiment, in each iteration, only one macro block mode is tested. This is also referred to as one R-D operation.

Let. MB_{i′,j}=MB*, if

J_{i′,j}(mode_{Test}, λ_{mode})<J_{i′,j}(mode_min(MB_{i′,j}), λ_{mode}) (8)

then the tested mode_{Test} is used to update the coding mode currently associated with the macro block according to

mode_min(MB_{i′, j})=mode_{Test}. (9)

In other words, if the tested coding mode gives a better coding performance level (in this example rate-distortion) for the macro block, the tested coding mode is associated with the macro block.

The iterative process of selecting the next macro block to be processed is for example continued until a predetermined number of R-D operations for the wave front Wⱼ have been carried out.

This number may for example be given by

Nₒₚ(Wⱼ)=└2y·|Wⱼ|┘ (10)

where |Wⱼ| denotes the number of macro blocks in Wⱼ and y is a control parameter.

After the processing of a wave front has been completed, the process continues with the next wave front. When all wave fronts have been processed, the encoding is finalized (based on the determined coding modes).

According to one embodiment, the encoding process is carried out in accordance with the following pseudo-code:

| | |
|---|---|
| 1: | while not all wave fronts completed R-D computation do |

| | |
|---|---|
| 2: | Compute SKIP mode for all macro blocks in wave front |
| 3: | while predetermined number of R-D operations has not |
| | been done do |

| | |
|---|---|
| 4: | identify macro block with the worst current R-D. |
| | performance |
| 5: | carry out next state of R-D optimization on that |
| | macro block (one R-D operation) |
| 6: | update R-D cost |

| | |
|---|---|
| 7: | end while |
| 8: | complete current wave front, move to next |

| | |
|---|---|
| 9: | end while |

The motivation for the macro block selection strategy in equation (7) may be seen as to divert computational resource to macro blocks with the worst R-D performance during the R-D optimization of a wave front. Since a typical wave front spans a large area across the image, it is likely to cover both areas with high and low motion activities. Macro blocks in the more complex regions of the image tend to have higher priority in the selection, thus benefiting from the extra R-D operations.

The encoder 100 described above with reference to FIG. 1 includes an enhancement layer module 102 and a base layer module 103, for example in accordance with scalable video coding (SVC).

Scalable video coding is an extension of H.264/AVC and is used to produce bit streams that can fulfil different spatial, temporal and SNR (signal to noise ratio) requirements through appropriate extraction.

The spatial and quality scalability can be achieved through encoding a video into layers (a base layer and one or more enhancement layers). When a video of higher resolution or better quality is desired, a client can request and decode enhancement layers that contain information for refining and enhancing the base layer pictures, i.e. the pictures reconstructed from only the base layer information.

In the base layer, motion vectors may be predicted from other motion vectors (e.g. from motion vectors determined for other, e.g. neighbouring, macro blocks) to exploit the correlation between the motion vectors of neighbouring macro blocks. For example, the motion vectors of a partitioning of a macro block (see FIG. 2) can be predictively coded based on the motion vectors of a partitioning of a neighbouring macro block that has already been coded.

In an enhancement layer a motion vector for a block may further be predicted based on the motion vector for a corresponding block (e.g. a block covering the same region of the picture) in the base layer.

As explained above, the testing of all macro block modes with and without residue prediction and motion vector prediction to determine the set of motion information that gives the best rate-distortion performance is computationally expensive. Accordingly, motion estimation for an enhancement layer macro block may also be time consuming and computationally expensive if the wide range of coding options available is used to improve coding efficiency.

In one embodiment, in accordance with SVC, during the encoding of an enhancement layer, e.g. the encoding carried out by the enhancement layer module 102, the mode of inter-layer prediction used (as represented by the inter prediction information 111) may be controlled. The mode of inter-layer prediction used in the encoding typically has direct effect on both the complexity and the coding efficiency of the encoding process.

For example, the encoder can select to not use inter-layer prediction and to encode each layer separately. It this case, a relatively poor coding performance can be expected since typically, much redundancy is present among the layers.

The encoder can also choose to always use the base layer motion information for the enhancement layer coding and carry out residual prediction. This may show better coding efficiency compared to coding layers separately. However, the performance of the encoder can still be improved since copying base layer motion information and residual prediction may not be optimal in a rate-distortion sense.

According to SVC, motion information and residual prediction may be carried out adaptively at the macro block level. A residual prediction flag may be used to inform the decoder whether residual prediction based on base layer residuals is carried for a particular macro block. Similarly, motion vectors in the enhancement layer can be predicted based on the base layer motion vectors. A base layer SKIP mode also may allow an enhancement layer macro block to inherit the motion information of its corresponding base layer macro block.

As explained above, with the wide array of coding options, determining the optimal coding mode for each macro block may be computation resource intensive. To assess the rate-distortion wise effectiveness of each mode, an encoder has to successively code a macro block with all possible combinations of coding modes so that the rate-distortion cost of each combination can be computed.

Without any heuristics to reduce the number of combinations to be tested in this way, to decide whether to use inter-layer prediction may involve the repetition of the motion search with and without each available inter-layer prediction mechanism (e.g. motion vector prediction from base layer and residual prediction from base layer). Although adaptively selecting the mode of inter layer prediction for each macro block may increase rate-distortion performance, it can also be expected to increase computational complexity.

Therefore, according to one embodiment, the encoding scheme described above with reference to FIG. 3 is used for enhancement layer encoding.

The encoding process for an enhancement layer may be carried out similarly to the encoding process described above.

The process may be modified to take advantage of the observation that an enhancement layer macro block (i.e. a macro block of a digital picture as it is input to the enhancement layer module 102) is often more finely partitioned compared to the corresponding base layer macro block in case that base layer and enhancement layer are of the same resolution (i.e. in case that there is no spatial decimation circuit 104.

According to one embodiment, the encoding of a wave front in the enhancement layer begins by computing the SKIP, INTRA and base layer SKIP mode for all macro blocks in the wave front. The first macro block mode tested for an enhancement layer macro block is based on the mode associated with the corresponding base layer macro block, for example according to table 2.

TABLE 2
Next macro block mode to test (enhancement layer)

| base layer macro | next macro block coding mode to test in |
|---|---|
| block coding mode | enhancement layer for MB* |
| SKIP | 16x16 |
| 16x16 | 16x16 |
| 16x8 | 16x8 |
| 8x16 | 16x8 |
| 8x8 | 8x8 |

The rule according to table 2 ensures that the enhancement layer macro block is always at least as finely partitioned as its corresponding base layer macro block and reduces the modes that have to be tested to a subset of all possible coding modes.

Similar to the base layer, the next enhancement layer macro block to be processed is determined by the current R-D performance (i.e. the R-D performance according to their respective currently associated coding mode) of all macro blocks in the wave front. The macro block with the current worst R-D performance is selected and the next coding mode is tested for it. This process is for example iterated until a predefined number of R-D operations have been carried out.

According to one embodiment, the encoding process for an enhancement layer is carried out in accordance with the following pseudo-code:

| | |
|---|---|
| 1: | while not all wave fronts completed R-D computation do |

| | |
|---|---|
| 2: | Compute SKIP, INTRA and Base Layer SKIP mode for all |
| | macro blocks in wave front |
| 3: | while predetermined number of R-D operations has not |
| | been done do |

| | |
|---|---|
| 4: | identify macro block with the worst current R-D |
| | performance |
| 5: | carry out next state of R-D optimization on that |
| | macro block (one R-D operation) |
| 6: | update R-D cost |

| | |
|---|---|
| 7: | end while |
| 8: | complete current wave front, move to next |

| | |
|---|---|
| 9: | end while |

In one embodiment, for applications where computational power is constrained or variable, the encoder computational complexity may be adaptively adjusted, for example to meet a certain (power) constraint.

Consider, for example, a group of pictures (GOP) of size N_{GOP} equal to four including one P frame and four B frames. A target GOP encoding time Tₜ can be computed to ensure that a required frame rate can be attained

Using the encoding time for the P frame T₀ as indication of the current computational resources and the complexity of the frame, the time required to encode each of the subsequent B frames can be estimated and the parameter y that controls the number of R-D operations per wave front (see equation (10)) can be adjusted to ensure that the encoding can be carried out in time.

It can be seen from experiments that in one embodiment, a value of y equal to 1 reduces the encoding time of a B frame to 0.6 T_{b} where T_{b} is the encoding time with exhaustive rate-distortion computation (i.e. exhaustive test of coding mode combinations).

Through extrapolation, a value of y equal to 0 (which can be interpreted as coding all macro blocks as SKIPPED or INTRA) gives an encoding time of around 0.6 T_{b}. Since the time left to encode a GOP after the P frame has been encoded is T₀-T_{b}, the time available for encoding for each B frame of the GOP, T_{bTarget}, is given by

$${T}_{bTarget} = \frac{{T}_{t} - {T}_{0}}{{N}_{GOP} - 1} . \qquad ( 11 )$$

In this case, y be simply chosen as

$$2 ( \frac{{T}_{bTarget}}{{\tilde{T}}_{b}} - 0.1 ) . \qquad ( 12 )$$

where \tilde{T}_{b} is the estimated time to exhaustively code the next B-frame.

Estimation of the encoding time of the next frame can also be based on the last frame that is being encoded. Typically, encoding time of a frame is likely to be similar to the previously encoded frame of the same temporal level.

Encoding times of frames of different temporal levels are likely to differ when a stop criterion stops the motion searches when SAD is smaller than a threshold as frames in the lower temporal level are temporally further apart. Generally, a larger search range and more search points are required when frames are temporally further apart and frames become less similar. As the encoding of a GOP progresses, the value of y can be adjusted before the encoding of each frame to ensure that encoding can be completed in time.

From experiments, it can be seen that the encoding scheme described above allows encoding to be carried out with about 40% complexity reduction with little drop in coding performance. Furthermore, it can be seen that since computation is channelled to the macro block currently having the highest rate-distortion cost, the encoding scheme described above allows reducing the rate-distortion cost of a wave front significantly faster (in course of the optimization process) than conventional methods. The ability to decrease the total R-D cost of a wave front more quickly improves the performance of the encoder in two ways:
The encoding scheme according to the embodiment described above can attain the coding performance near to that of an exhaustive search encoder with a significantly smaller number of computations;
by controlling the number of computations per wave front, the complexity of the encoder can be controlled. The computational resources are channelled to the currently worst performing (in an R-D cost sense) macro block.

Other than demonstrating the reduction in the number of function calls during the encoding process it can be shown that the reduction is across all macro block operations at the macro block level. The complexity scalable encoding scheme according to the embodiment described above can be useful as it can be expected to work well with other complexity reduction techniques.

An encoding scheme that tries to control encoder complexity by controlling the motion estimation search range can be expected to become less effective if a faster implementation of the SAD operation is used (possibly through the use of SIMD (single instruction multiple data) instructions or some effective fast search algorithms) and the SAD operations are no longer the bottleneck in the encoding operations.

Controlling the computational resource allocation as described above tends to channel limited resource to macro blocks that benefit most from the extra computations. Since a R-D computation for a particular partition includes different operations that can be computationally complex (e.g. motion estimation, transforms and inverse transforms for the computation of rates and distortions), good complexity control can be expected even if these sub-operations of the R-D computation are implemented with lower complexity.

The effectiveness of the encoding scheme according to an embodiment can also be observed in the scalable extension, i.e. used for an enhancement layer as described above. It can be seen from experiments that the encoding time on the same computing platform (or equivalently the power consumption of the video encoder) can be controlled by a single parameter (e.g. y).

The ability to control the complexity of the encoding at each layer also provides insights on the allocation of computational resource across the layers. When the enhancement layer always reuses the base layer motion information, coding performance at the enhancement layer may suffer as the motion information acquired at the base layer is not optimized for the enhancement layer. Encoding the enhancement layer in this mode is however, relatively less complex as no R-D computation is carried out in the enhancement layers.

All computational resources may be invested in acquiring an optimal motion vector field for the base layer. The enhancement layer then reuses this information and refines only the residual information.

By setting y values independently in different layers, the computational resource allocation to each layer can be controlled leading to a more efficient use of resource. As can be shown by experiment, channelling resource from base to enhancement layer is likely to lead to better performance compared to only optimizing motion information in the base layer.

Optimizing the base layer and then reusing the motion information in the enhancement layers is a possible low complexity option. However, when there is a constraint in computational resource, experiment results show that it is not the best way to allocate limited resource and investing some resource in the refinement of motion information in the enhancement layers will probably lead to better overall coding performance.

It can further be shown that when less resource are invested during the rate-distortion optimization in the base layer, the coding efficiency at the enhancement layer may also be affected. When the base layer motion information is closer to optimal, due to the higher number of computations that was carried out in the complexity scalable scheme, the base layer motion information available for reuse may also be better suited for the enhancement layer (despite it being optimized for a lower bit-rate).

As the bit-rate between the base layer and the enhancement layer widens, the motion vector information may become less optimal for the enhancement layer and the coding performance may worsen relative to the case of using exhaustive R-D optimization.

Being able to separately control the complexity of encoding at each layer allows the encoder to optimize each layer to different extent depending on the importance of each layer or the requirements of the receiver of the encoded digital picture sequence. When computational resources are limited, channelling resource to the R-D operations in the enhancement layers at the expense of base layer may be a good idea, especially when the bit-rates of the two layers are significantly different and the base layer motion information is far from optimized for the enhancement layers.

According to one embodiment, a method for complexity scalable video encoding is provided including determining a rate distortion (R-D) of at least one macro block in a group of macro blocks of a frame, wherein the macro blocks of the group of macro blocks are adjacent to each other. The group of macro blocks is selected such that it spans across the frame (or picture) to be encoded. Macro blocks within a group can be operated on independently and concurrently. R-D computation for a particular group is carried out by iteratively operating on macro blocks in the group for a predetermined number of operations.

In one embodiment, the R-D computation for each macro block of a group of macro blocks is performed concurrently. In another embodiment, the R-D is determined for each macro block of the group of macro blocks with respect to the R-D of adjacent macro blocks of the group of macro blocks.

According to one embodiment, computational resources are directed accordingly to the macro blocks that require the most processing. This further permits the computation of R-D in a complexity scalable fashion without degrading the coding performance too drastically in the AVC (advanced video coding) or SVC scheme. In addition, the selection of a group of macro blocks across a frame covers a large area of the image and it is likely that areas with high and low motion activities are considered.

1. A method for encoding a digital picture having a plurality of pixels, each pixel being associated with at least one of a plurality of groups of pixels comprising
associating each group of pixels of the plurality of groups of pixels with a first coding mode of a plurality of different coding modes;
determining, for each group of pixels, a first encoding performance level specifying an encoding performance level of the group of pixels when encoded according to its associated first coding mode;
determining at least one group of pixels of the plurality of group of pixels such that the first encoding performance level of the at least one determined group of pixels fulfils a predetermined quality criterion relative to the first encoding performance level of the other groups of pixels of the plurality of groups of pixels;
determining, for the determined group of pixels, a second encoding performance level, specifying an encoding performance level of the group of pixels when encoded according to a second coding mode which is different from the first coding mode;
comparing the first performance level and the second performance level;
associating the second coding mode with the determined group of pixels if the result of the comparison fulfils a predetermined association criterion; and
encoding each group of pixels using its associated coding mode.

2. The method according to claim 1, wherein each group of pixels covers a continuous area of the digital picture.

3. The method according to claim 2, wherein the size and shape of the continuous area is equal for all groups of pixels.

4. The method according to claim 1, wherein the groups of pixels are blocks.

5. The method according to claim 4, wherein the groups of pixels are macro blocks.

6. The method according to claim 1, wherein the first encoding performance level fulfils the quality criterion if is below a threshold.

7. The method according to claim 1, wherein the first encoding performance level fulfils the quality criterion if it is a lowest encoding performance level of the first encoding performance levels.

8. The method according to claim 1, wherein the result of the comparison fulfils the predetermined association criterion if the second encoding performance level is higher than the first encoding performance level.

9. The method according to claim 1, wherein the result of the comparison fulfils the predetermined association criterion if the second encoding performance level is at least as high as the first encoding performance level.

10. The method according to claim 1, wherein the encoding performance level of a group of pixels when encoded according to a coding mode is the rate-distortion performance of the group of pixels.

11. The method according to claim 1, comprising carrying out a plurality of iterations wherein in each iteration
a current encoding performance level is determined for each group of pixels specifying a current encoding performance level of the group of pixels when encoded according to its currently associated coding mode;
at least one group of pixels of the plurality of group of pixels for the current iteration is determined such that the current encoding performance level of the at least one determined group of pixels for the current iteration fulfils the predetermined quality criterion;
a test encoding performance level is determined for the determined group of pixels for the current iteration, specifying an encoding performance level of the group of pixels when encoded according to a test coding mode which is different from the current coding mode;
the current performance level and the test performance level are compared;
the test coding mode is associated with the determined group of pixels for the current iteration if the result of the comparison fulfils the predetermined association criterion.

12. The method according to claim 11, wherein the at least one group of pixels of the plurality of group of pixels for the current iteration is determined by a comparison of current encoding performance levels of the plurality of group of pixels.

13. The method according to claim 11, wherein the iterations are carried out until a termination condition is fulfilled.

14. The method according to claim 13, wherein the termination condition is determined based on available computational resources.

15. The method according to claim 12, wherein the termination condition is a maximum number of iterations being reached.

16. The method according to claim 13, wherein the termination condition is based on an estimation of computational resources necessary for encoding the digital picture.

17. The method according to claim 13, wherein the termination condition is based on an estimation of the time necessary for encoding the digital picture.

18. The method according to claim 1, wherein the second coding mode is determined from the first coding mode in accordance with a pre-determined rule.

19. The method according to claim 1, wherein the digital picture is encoded according to a base layer and according to an enhancement layer, wherein the coding mode associated with the determined group in the enhancement layer is determined from a coding mode associated with the determined group of pictures to be used for encoding the digital picture in accordance with the base layer in accordance with a pre-determined rule.

20. The method according to claim 1, wherein the digital picture is encoded according to a base layer and according to an enhancement layer, wherein the first coding mode associated with the determined group is a coding mode to be used for encoding the digital picture in accordance with the enhancement layer and the second coding mode is determined from a coding mode associated with the determined group of pictures to be used for encoding the digital picture in accordance with the base layer in accordance with a pre-determined rule.

21. The method according to claim 1, wherein the first coding mode and the second coding mode specify, for a group of pixels, a partitioning of the group of pixels.

22. The method according to claim 21, wherein the partitioning of the group of pixels is used as a basis for a prediction of pixel values of the group of pixels in encoding the group of pixels.

23. The method according to claim 22, wherein the partitioning of the group of pixels is used as a basis for a prediction of pixel values of the group of pixels in encoding the group of pixels by motion estimation.

24. An encoder for encoding a digital picture having a plurality of pixels, each pixel being associated with at least one of a plurality of groups of pixels, comprising:
a first associating circuit configured to associate each group of pixels of the plurality of groups of pixels with a first coding mode of a plurality of different coding modes;
a first determining circuit configured to determine, for each group of pixels, a first encoding performance level specifying an encoding performance level of the group of pixels when encoded according to its associated first coding mode;
a second determining circuit configured to determine at least one group of pixels of the plurality of group of pixels such that the first encoding performance level of the at least one determined group of pixels fulfils a predetermined quality criterion relative to the first encoding performance level of the other groups of pixels of the plurality of groups of pixels;
a third determining circuit configured to determine, for the determined group of pixels, a second encoding performance level, specifying an encoding performance level of the group of pixels when encoded according to a second coding mode which is different from the first coding mode;
a comparing circuit configured to compare the first performance level and the second performance level;
a second associating circuit configured to associate the second coding mode with the determined group of pixels if the result of the comparison fulfils a predetermined association criterion; and
an encoding circuit configured to encode each group of pixels using its associated coding mode.

25. A computer program element comprising instructions which, when executed by a computer, make the computer perform a method for encoding a digital picture having a plurality of pixels, each pixel being associated with at least one of a plurality of groups of pixels comprising
associating each group of pixels of the plurality of groups of pixels with a first coding mode of a plurality of different coding modes;
determining, for each group of pixels, a first encoding performance level specifying an encoding performance level of the group of pixels when encoded according to its associated first coding mode;
determining at least one group of pixels of the plurality of group of pixels such that the first encoding performance level of the at least one determined group of pixels fulfils a predetermined quality criterion relative to the first encoding performance level of the other groups of pixels of the plurality of groups of pixels;
determining, for the determined group of pixels, a second encoding performance level, specifying an encoding performance level of the group of pixels when encoded according to a second coding mode which is different from the first coding mode;
comparing the first performance level and the second performance level;
associating the second coding mode with the determined group of pixels if the result of the comparison fulfils a predetermined association criterion; and
encoding each group of pixels using its associated coding mode.
